(19) United States
(12) Patent Application Publication
(10) Pub. No.: US 2007/0235526 A1
(43) Pub. Date: Oct. 11, 2007

(54) System for preventing banned drivers from driving

(75) Inventors: Itzhack Goldberg, Hadera (IL); Pnina Vortman, Haifa (IL)

Correspondence Address: Stephen C. Kaufman;IBM CORPORATION, Intellectual Property Law Dept., P. O. Box 218, Yorktown Heights, NY, 10598, US

(73) Assignee: International Business Machines Corporation, Armonk, NY (US)

(21) Appl. No.: 11/404,488

(22) Filed: Apr. 11, 2006

(51) Int. Cl. G06K 5/00; G07B 15/02

(52) U.S. Cl. 235/382; 235/384

(57) ABSTRACT

A system for allowing access to a driver of a vehicle based on validity information of the driver is provided. The system requires the driver to insert a valid driving license card into a card reader installed in the vehicle for checking the validity of the driving license card of the driver. The system provides access to the driver of the vehicle only if the card reader validates the driving license card of the driver. The system may also store parameter information of the vehicle onto the driving license card during the drive. The validity information stored in the driving license card may be updated by the card writer or traffic authorities based on the parameter information.

### BACKGROUND OF THE INVENTION

Statistics shows that a large number of road causalities are caused due to traffic offences. Many of these traffic offences may be a result of driving of vehicles at high speed by the drivers. High speed driving may lead to violation of traffic rules. Over a period of time such drivers develop bad driving habits and tend to violate traffic rules very frequently. Monitoring the driving habits of a driver is required to avoid such traffic offences. Despite stringent traffic law and regular actions taken by the police and local authorities, many such drivers continue driving at high speeds thereby leading to the public hazard.

To reduce the number of causalities due to traffic offences, traffic authorities should be able to monitor the driving habits of a driver. This would enable the traffic authorities to note any violations of traffic rules and ban a driver for repeat violations. The existing solutions available to the traffic authorities for monitoring driving habits of drivers involve installing cameras at predetermined locations, setting up check-points on the roads at predetermined distances etc. All these existing solutions have the limitation that driving habits of the driver can not be monitored continuously.

Further even when drivers are banned from driving for violating traffic rules, there is no way to ensure that a banned driver is prevented from accessing a vehicle. Many of these banned drivers continue to drive the vehicles and may lead to further violations of traffic rules.

Therefore, there is a need of a system to monitor the driving habits of drivers and to prevent a banned driver from driving a vehicle.

### SUMMARY

The present invention is directed to a system for providing access to a driver of a vehicle based on validity information of the driver. The system prevents a banned driver from driving the vehicle.

The system comprises a card reader installed in the vehicle and a starting circuit connected to the card reader. The card reader validates a driving license card by checking the validity information of the driver stored in the driving license card. The starting circuit controls the ignition circuit of the vehicle and activates the ignition circuit upon validation of the driving license card. Thus only the drivers carrying valid driving license cards are allowed access to the vehicle.

In another embodiment of the invention, the system further comprises a card writer storing parameter information on the readable-writable memory space of the driving license card. The system may be used to update the validity information of the driver based on the parameter information stored in the driving license card.

These and other features, aspects and advantages of the present invention will become better understood with reference to the following description and appended claims.

### BRIEF DESCRIPTION OF DRAWINGS

FIG. 1 shows a schematic view of a system provided by the present invention to provide access of a vehicle to a driver based on the validity information of the driver.

FIG. 2 is a schematic view of another embodiment of the system provided by the present invention. The embodiment has a card writer connected to the card reader to monitor the parameters information of the vehicle.

FIG. 3 illustrates an exemplar version of the driving license card used in the present invention.

FIG. 4 is a block diagram representation of a typical method for providing access of a vehicle to a driver with a valid driving license according to the present invention.

### DETAILED DESCRIPTION

The present invention relates to system for providing access to a driver of a vehicle based on validity information of the driver. The invention gets the validity information of the driver from a driving license card of the driver.

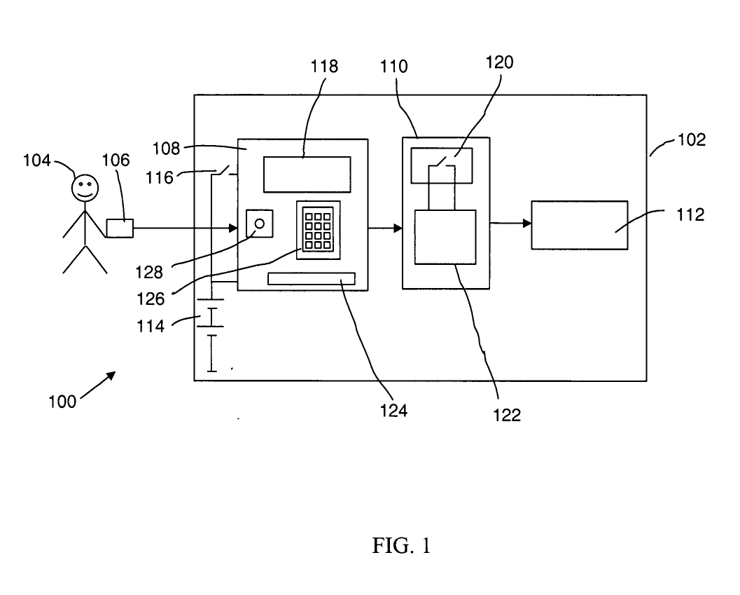

FIG. 1 is a schematic view of a system 100 provided by the present invention to provide access of a vehicle 102 to a driver 104 based on the validity information of driver 104. System 100 comprises a driving license card 106, a card reader 108, a starting circuit 110 and an ignition circuit 112. Driving license card 106 comprises a machine-readable memory space for storing personalized information of driver 104. The personalized information of driver 104 may be stored in an encrypted form on driving license card 106. The personalized information may contain identification information of driver 104 and the validity information of driving license card 106 of driver 104. The identification information may contain personal identification number (PIN), fingerprint data, or other biometric data. The validity information contains a code representing the validity of driving license card 106. Thus the validity information code can have two values—one for a valid driving license card and another for an invalid license card.

Card reader 108 comprises a memory space 118 to store the standardized validity codes for both valid and invalid driving license cards 106. The standardized validity codes stored in card reader 108 may be compared with the validity information codes on driving license card 106 to provide access only to drivers with valid license card. Memory space 118 of card reader 108 may further comprise standardized identification information for one or more drivers of vehicle 102. The standardized identification information may contain personal identification number (PIN), fingerprint data, or other biometric data for the drivers pre-authorized to access vehicle 102. Card reader 108 is connected to a battery 114 for supplying power and a switch 116 for controlling the power supply from battery 114. Starting circuit 110 is connected to ignition circuit 112 and may be used for activating ignition circuit 112 for starting vehicle 102. Starting circuit 110 comprises a switch 120 and an analyzer 122. Analyzer 122 gets notification from card reader 108 and may turn switch 120 into an active state from a default inactive state, depending on the notification. The active state of switch 120 in turn activates ignition circuit 112 and allows vehicle 102 to be started.

Driver 104 needs to insert driving license card 106 into card reader 108 to get access to vehicle 102. Card reader 108 reads the personalized information stored in driving license card 106. Card reader 108 compares the validity information codes available on memory space of driving license card 106 with the standardized codes stored in memory space 118 of card reader 108. In case the validity information code of driving license card 106 matches with standardized code for valid driving license stored in memory 118, card reader 108 validates driving license card 106. Card reader 108 notifies analyzer 122 that driving license card 106 has been validated. Upon validation, switch 120 is turned into an active state which in turn activates ignition circuit 112 and allows vehicle 102 to be started.

However if the validity information of driving license card 106 denotes an invalid driving license card 106 switch 120 remains in the default inactive state and ignition circuit 112 is not activated. Thus the driver with an invalid driving license card is unable to get access of vehicle 102.

Card reader 106 may further comprise an identification module 124. Identification module 124 may be used for identifying one or more pre-authorized drivers of vehicle 102 or for preventing misuse of stolen driving license cards 106.

Identification module 124 comes into play once the validation of driving license card is complete. At this stage identification module may request driver 104 to enter identification information. The identification information may include a personal identification number (PIN) known to a pre-authorized driver. The driver may enter the PIN using a keypad 124. The identification information may also include fingerprint, retina or other biometric information. In this case identification module 124 may be provided with a fingerprint analyzer, a retina analyzer or some other type of biometric analyzer for reading and analyzing biometric information.

In one embodiment, the identification information entered by driver 104 is compared with the standardized identification information stored in memory space 118 of card reader 108. A notification is sent to starting circuit 110 only when both validity information and identification information have been authenticated. This embodiment ensures that only the pre-authorized drivers carrying authentic validity information and identification information are provided access to vehicle 102.

In an alternate embodiment, identification module 124 compares identification information entered by driver 104 with identification information stored in driving license card 106. This embodiment prevents the use of stolen driving license cards.

Card reader 108 may further comprise of a data transfer socket 126 to permit the identification information loading-unloading from memory 118 or from the memory space of driving license card 106.

In one embodiment of the invention, driving license card 106 remains inserted in card reader 108 throughout the drive.

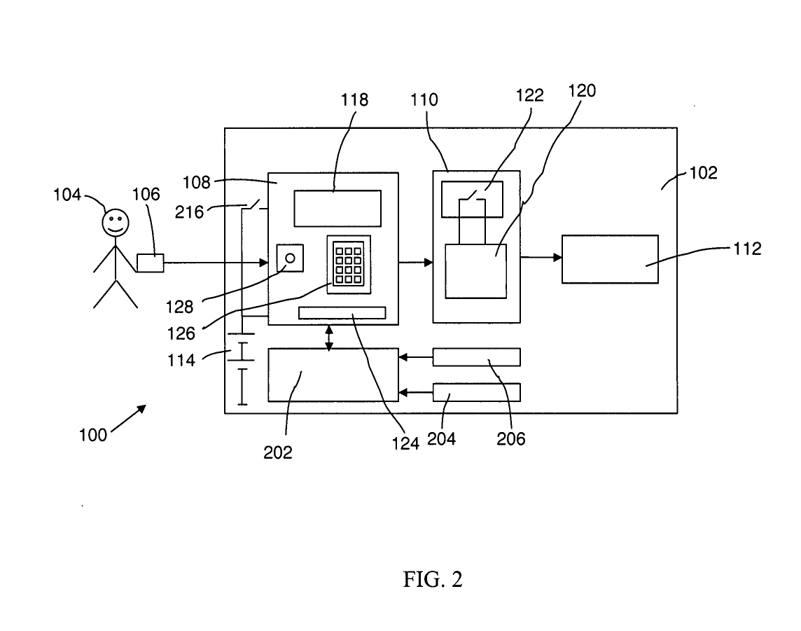

FIG. 2 is a schematic view of another embodiment of system 100 provided by the present invention. The embodiment shows a card writer 202 connected to card reader 108, and sensors 204 and 206 for monitoring the parameter information of vehicle 102. Driving license card 108 has a readable-writable memory space. The data transfer socket 126 may be used to permit the identification information loading-unloading from the readable-writable memory space of driving license card 106. In one embodiment, card writer 202 is integrated with card reader 108.

Card writer 202 is used for storing parameter information of vehicle 102 on the readable-writable memory space of driving license card 108. Card writer 202 is connected to sensors 204 and 206. Sensors 204 and 206 monitor the parameters of the vehicle and provide parameter information to card writer 202. Card writer 202 stores this parameter information on the readable-writable memory space of driving license card 108. Card writer 202 may also update the validity information of the driver based on the parameter information stored in driving license card 108.

In one embodiment sensors 204 and 206 are speed and acceleration sensors and respectively monitor the speed and acceleration of vehicle 102. It will be obvious to one skilled in the art that any other parameters of vehicle 102 may be monitored and stored.

In one embodiment, card writer 202 stores the parameter information on a continuous basis. In another embodiment card writer 202 may comprise an exception module comparing the parameter information of the vehicle with pre-stored parameter range information and storing any instances of exception. The pre-stored parameter range may vary depending on the traffic rules, travel route etc.

The parameter information stored in driving license card 106 determines the validity information of the driver. Thus card writer 202 may convert a valid license card into an invalid license card based on the parameter information stored in driving license card 106.

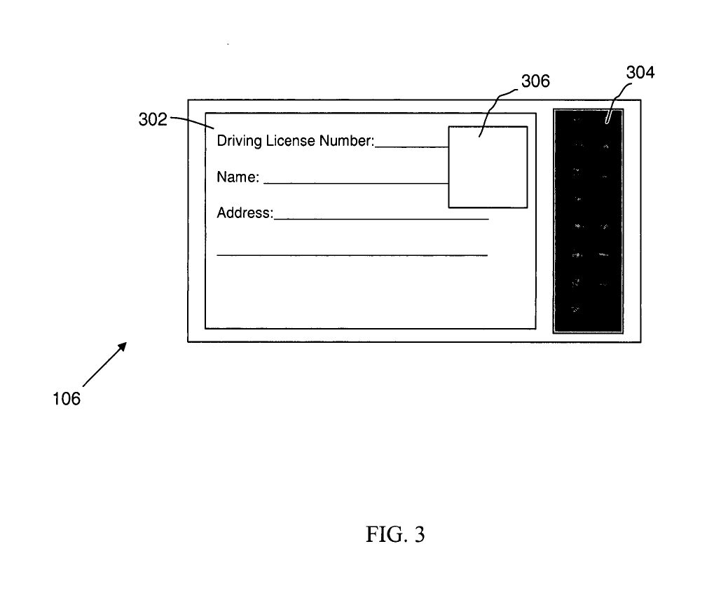

FIG. 3 is a schematic illustrating a driving license card 106. As shown, driving license card 106 comprises a printed section 302 containing the printed personal details of the driver and a readable-writable memory space 304. Printed section 302 contains details such as name, driving license number and a picture image 306 of the driver.

Readable-writable memory space 304 stores the validity information and identification information of the driving license. Readable-writable memory space 304 may also store parameter information of the vehicles driven by the driver carrying driving license card 106. The parameter information stored in readable-writable memory space 304 can be used by the traffic authorities during inspection.

On the basis of parameter information stored in readable-writable memory space 304, the traffic authorities may take actions for any traffic rule violation instances by the driver, such as exceeding speed limits. For example, the traffic authorities may invalidate driving license card 306 of a driver. The traffic authorities may use a system comprising card reader-writer assembly similar to the card reader-writer assembly installed in vehicle 102. The card reader can read the parameter information stored in readable-writable memory space 304 for detecting traffic rule violations while the card writer may be used to edit validity information in readable-writable memory space 304 thereby rendering the card invalid.

In another embodiment of the present invention, card writer 202 can automatically invalidate driving license card 106 on basis of pre-set number of traffic violation instances by the driver.

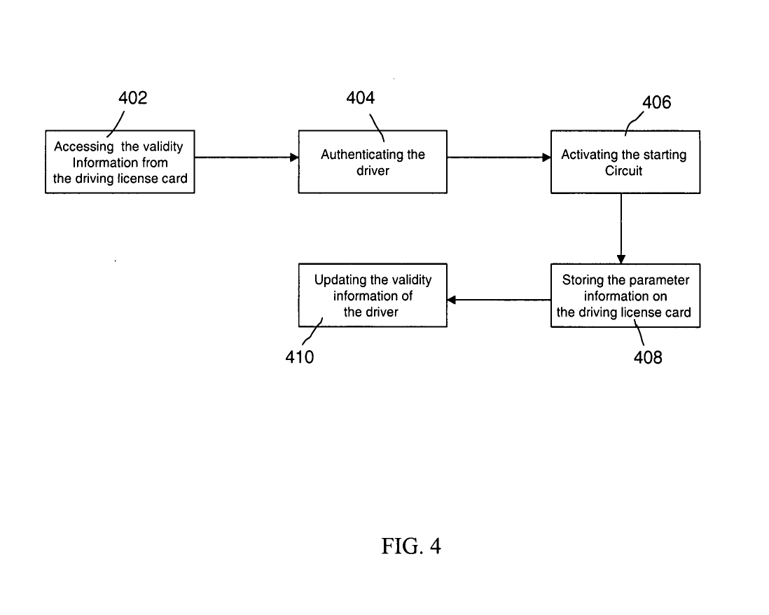

FIG. 4 is a block diagram representation of a typical method for providing access of vehicle 102 to driver 104 with a valid driving license according to the present invention. At step 402, card reader 108 accesses the validity information of the driving license from memory space of driving license card 106. At step 404, card reader 108 compares the validity information codes available on memory space of the driving license card with the standardized validity codes stored in memory space 118. Further if the validity information code of driving license card 106 matches with standardized validity code for valid driving license stored in memory 118, card reader 108 notifies analyzer 122 that driving license card 106 has been validated. At step 406, starting circuit activates switch 120 causing ignition circuit 112 to enter into state that allows vehicle 102 to be started. At step 408, card writer 202 gets input from different sensors during the drive and stores the parameter information of vehicle 102 onto readable-writable memory space of driving license card 106. At step 410, the validity information stored in driving license card 106 is updated on the basis of parameter information stored in driving license card 106.

In one embodiment, the validity information may be updated by card writer 202 automatically. For example, a valid driving license card can be automatically invalidated by card writer 202 based on a pre-set number of traffic violation instances by the driver.

In an alternate embodiment, the validity information is updated by the traffic authorities upon inspection.

What is claimed is:

1. A system for providing access to a driver of a vehicle based on validity information of the driver, the system comprising:
a card reader validating a driving license card by checking the validity information of the driver stored on the driving license card; and
a starting circuit connected to the card reader, the starting circuit controlling the ignition circuit of the vehicle, the starting circuit activating the ignition circuit upon validation of the driving license card.

2. The system as claimed in claim 1 wherein the driving license card remains inserted in the card reader throughout the drive.

3. The system as claimed in claim 1 wherein the card reader further comprises an identification module comparing standardized identification information in the card reader with identification information provided by the driver.

4. The system as claimed in claim 3 wherein the identification module performs a biometric check for identifying the driver.

5. The system as claimed in claim 3 wherein the identification module compares a personal identification number stored in the card reader with a personal identification number entered by the driver.

6. A system comprising:
a machine readable driving license card storing validity information of a driver of a vehicle;
a card reader installed in the vehicle, the card reader validating the driving license card by checking the validity information stored on the driving license card; and
a starting circuit connected to the card reader, the starting circuit controlling the ignition circuit of the vehicle, the starting circuit activating the ignition circuit upon validation of the driving license card.

7. The system as claimed in claim 6 wherein the driving license card is a smart card.

8. The system as claimed in claim 6 wherein the driving license card stores the identification information of the driver of the vehicle.

9. The system as claimed in claim 7 wherein the card reader further comprises an identification module comparing identification information stored on the driving license card with identification information provided by the driver.

10. The system as claimed in claim 8 wherein the identification module performs a biometric check for comparing the identification information provided by the driver with the identification information stored on the driving license card.

11. The system as claimed in claim 8 wherein the identification module compares a personal identification number stored in the driving license card to the personal identification number entered by the driver.

12. A system for providing access to a driver of a vehicle based on validity information of the driver, the system comprising:
a machine readable driving license card with readable-writable memory space;
a card reader installed in the vehicle, the card reader validating the driving license card by checking the validity information stored on the readable-writable memory of the driving license card;
a starting circuit connected to the card reader, the starting circuit controlling the ignition circuit of the vehicle, the starting circuit activating the ignition circuit upon validation of the driving license card; and
a card writer storing parameter information on the readable-writable memory space of the driving license card and updating the validity information of the driver based on the parameter information stored in the driving license card.

13. The system as claimed in claim 12 wherein the card writer is integrated with the card reader.

14. The system as claimed in claim 12 wherein the card writer comprises sensors for monitoring the parameters of the vehicle.

15. The system as claimed in claim 12 wherein the parameter information includes the speed of the vehicle.

16. The system as claimed in claim 12 wherein the card writer stores the parameter information on a continuous real time basis.

17. The system as claimed in claim 12 wherein the card writer comprises an exception module comparing the parameter information of the vehicle with pre-stored parameter range information and storing any instances of exception.
